(19) United States
(12) Patent Application Publication
(10) Pub. No.: US 2008/0172203 A1
(43) Pub. Date: Jul. 17, 2008

(54) ACCURATE STEP COUNTER

(75) Inventor: Filip Jorgensen, Lund (SE)

Correspondence Address: HARRITY SNYDER, L.L.P., 11350 RANDOM HILLS ROAD, SUITE 600, FAIRFAX, VA, 22030, US

(73) Assignee: SONY ERICSSON MOBILE COMMUNICATIONS AB, Lund (SE)

(21) Appl. No.: 11/623,588

(22) Filed: Jan. 16, 2007

(51) Int. Cl. G01C 22/00

(52) U.S. Cl. 702/160

(57) ABSTRACT

A device may obtain samples from an accelerometer and a gyroscope, determine kinematics signals based on the samples, and compute a number of steps taken by a user based on the kinematics signals.

### TECHNICAL FIELD OF THE INVENTION

Implementations described herein are related to pedometers and in particular, pertain to methods and devices for counting the number of steps that are taken by a device carrier.

### DESCRIPTION OF RELATED ART

A pedometer has the ability to count the number of steps taken by its user. For accurate measurements, such a device may require its physical orientation to be constant relative to its user. However, in cases where the pedometer is incorporated into another device such as a phone, the pedometer's orientation may not stay constant, depending on how the device is carried. For example, if the device is carried in a purse or a pocket, the device may tumble, rotate or turn. In these instances, the pedometer may miscount the steps.

### SUMMARY

According to one aspect, a method may comprise obtaining samples from an accelerometer and a gyroscope, determining kinematics signals based on the samples, and computing a number of steps taken by a user based on the kinematics signals.

Additionally, determining kinematics signals may include determining an acceleration signal, a velocity signal, or a distance signal.

Additionally, the method may further comprise removing noise from the obtained samples.

Additionally, the method may further comprise receiving an average step length from the user.

Additionally, computing a number of steps includes computing the number of steps taken by the user based on the kinematics signals and the average step length.

Additionally, determining kinematics signals may include numerically solving equations of motion to determine kinematics signals based on the samples.

Additionally, the method may further comprise receiving samples from a Global Positioning System (GPS) receiver.

Additionally, determining kinematics signals may include numerically solving equations of motion based on the samples that are obtained from the accelerometer, the gyroscope, and the GPS receiver.

Additionally, the method may further include initializing the kinematics signals.

According to another aspect, a device may comprise an accelerometer for providing acceleration measurements, a gyroscope for providing angular rate measurements, and a processor. The processor may accept the acceleration measurements from the accelerometer and the angular rate measurements from the gyroscope, may establish kinematics signals based on the acceleration measurements and the gyroscope measurements, and may count a number of user foot steps based on the kinematics signals and an average step length.

Additionally, the kinematics signals may include a velocity signal, an acceleration signal, or a distance signal.

According to yet another aspect, a device may comprise a Global Positioning System (GPS) receiver for providing position measurements and velocity measurements, an accelerometer for providing acceleration measurements, a gyroscope for providing angular rate measurements, and a processor. The processor may accept the position measurements from the GPS receiver, the velocity measurements from the GPS receiver, the acceleration measurements from the accelerometer, and the angular rate measurements from the gyroscope. Additionally, the processor may establish kinematics signals based on the position measurements, the velocity measurements, the acceleration measurements, and the angular rate measurements. Additionally, the processor may count user foot steps by comparing the kinematics signals and reference kinematics signals.

Additionally, the kinematics signals may include a velocity signal, a acceleration signal, and a distance signal.

According to a further aspect, a device may comprise means for detecting acceleration in a first coordinate frame, means for detecting angular rates in the first coordinate frame, means for determining kinematics signals in a second coordinate frame based on the detected acceleration and the detected angular rates, and means for counting steps based on the kinematics signals.

Additionally, the kinematics signals may include an acceleration signal, a velocity signal, and a distance signal in three dimensions.

Additionally, the device may further comprise means for removing noise from the detected acceleration.

Additionally, the device may further comprise means for receiving the average step length from a user that is carrying the device.

Additionally, the means for counting steps may include means for counting steps taken by the user based on the kinematics signals and the average step length.

Additionally, the device may further comprise means for solving equations of motion to determine the kinematics signals based on the detected acceleration and the detected angular rates.

According to a further aspect, a portable device may comprise an accelerometer for providing acceleration measurements and a gyroscope for providing angular rate measurements. The device may further comprise a processor to accept the acceleration measurements from the accelerometer and the angular rate measurements from the gyroscope, establish kinematics signals based on the acceleration measurements and the gyroscope measurements by solving equations of motions, and measure a distance traveled based on the kinematics signals. The device may further comprise a housing that contains components of the portable device, the components including the accelerometer, the gyroscope, and the processor.

Additionally, the housing may include a cellular phone housing, a laptop housing, an electronic notepad housing, or a personal digital assistant (PDA) housing, a pager housing, or a mobile telephone housing.

### BRIEF DESCRIPTION OF THE DRAWINGS

The accompanying drawings, which are incorporated in and constitute a part of this specification, illustrate one or more embodiments described herein and, together with the description, explain the embodiments. In the drawings,

FIG. 1 depicts an exemplary device in which systems and methods described herein can be implemented;

FIG. 2 shows a functional block diagram of the exemplary device of FIG. 1;

FIG. 3A illustrates a perspective block diagram of an exemplary accelerometer in a three-dimensional Cartesian coordinate system that is affixed to the accelerometer;

FIG. 3B illustrates the exemplary accelerometer and the coordinate system in FIG. 3A after the accelerometer moves;

FIG. 4 shows an exemplary process for counting steps;

FIG. 5 illustrates a device coordinate frame of reference, an Earth-centric frame of reference, and an inertial coordinate frame of reference;

FIG. 6 shows another exemplary process for counting steps; and

FIG. 7 shows an exemplary phone that includes the device of FIG. 2.

### DETAILED DESCRIPTION OF EMBODIMENTS

The following detailed description refers to the accompanying drawings. The same reference numbers in different drawings may identify the same or similar elements. In addition, the term “signal samples” may refer to a sequence of values or numbers that are derived from a signal. Depending on context, the term “signal” and “signal samples” may be used interchangeably. The term “kinematics signal” may refer to signals that signify acceleration, velocity, and/or distance as function of time in one, two, or three dimensions.

### Exemplary Device

In the following implementations, a device with an accelerometer and a gyroscope may accurately count user steps. In one implementation, measurements from the accelerometer and the gyroscope may be combined to produce signals in a reference coordinate frame. The signals may be processed to count the user steps and/or to measure distance.

In another implementation, the device may include an accelerometer, a gyroscope, and a Global Positioning System (GPS) receiver. Measurements from the accelerometer, the gyroscope, and the GPS receiver may be combined to produce signals in a reference coordinate frame. The signals may be processed to count the user steps and to measure distance.

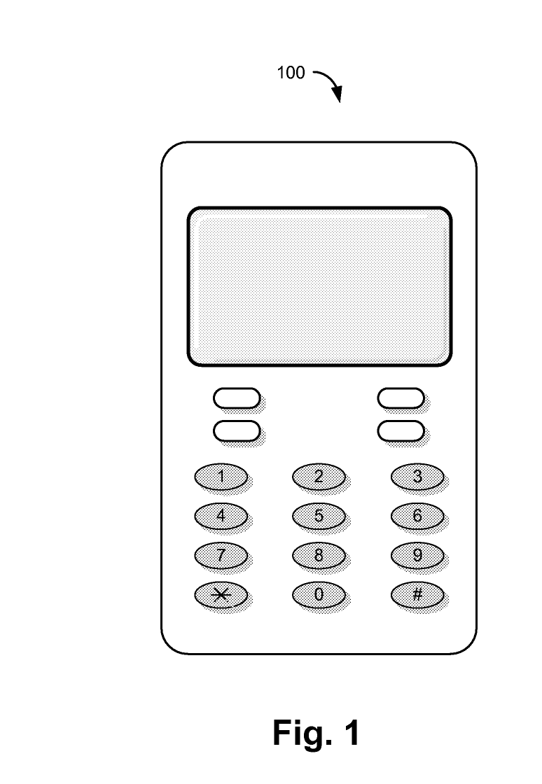

FIG. 1 depicts an exemplary device 100 in which systems and methods described herein can be implemented. Device 100 may include any of the following devices: a radio telephone; a personal communications system (PCS) terminal that may combine cellular radiotelephone with data processing, facsimile, and data communications capabilities; a mobile telephone; an electronic notepad; a laptop; a personal computer (PC); a personal digital assistant (PDA) that can include a radiotelephone, pager, Internet/intranet access, web browser, organizer, calendar, and/or GPS receiver; or any device with sufficient computing power and memory to support functions described herein.

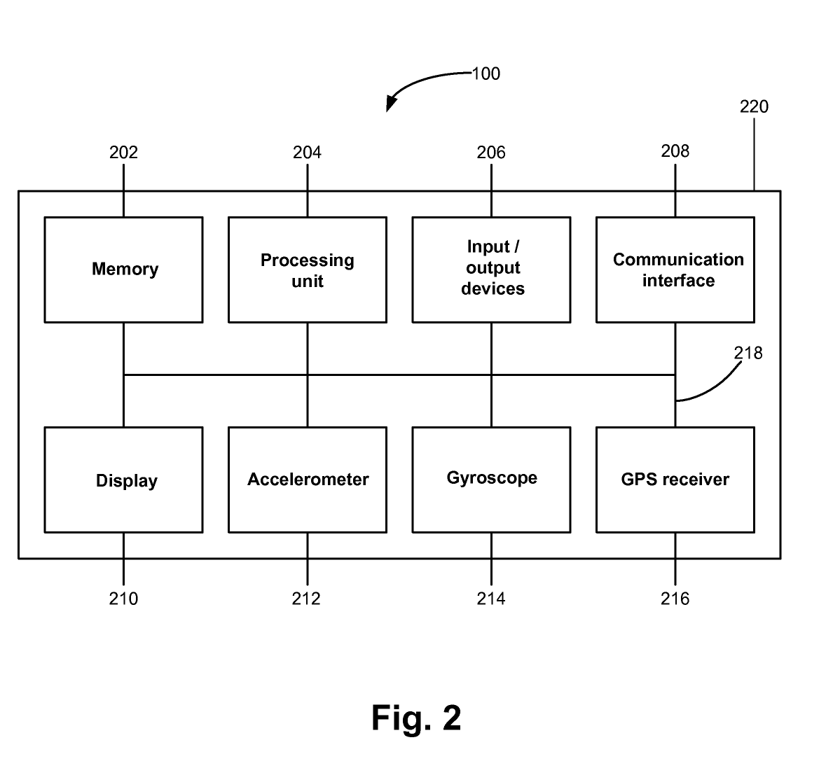

FIG. 2 shows a functional block diagram of exemplary device 100. Device 100 may include memory 202, processing unit 204, input/output devices 206, communication interface 208, display 210, accelerometer 212, gyroscope 214, GPS receiver 216, and communication bus 218. Memory 202 may include static memory, such as read only memory (ROM), and/or dynamic memory, such as random access memory (RAM), or onboard cache, for storing data and machine-readable instructions. Memory 202 may also include storage devices, such as a floppy disk, CD ROM, CD read/write (R/W) disc, and/or flash memory, as well as other types of storage devices.

Processing unit 204 may include one or more processors, microprocessors, and/or processing logic capable of controlling device 100. Input/output devices 206 may include a keyboard, button, mouse, speaker, microphone, digital camera, digital video camera, and/or another type of device for converting physical events or phenomena to and/or from digital signals that pertain to device 100.

Communication interface 208 may include any transceiver-like mechanism that enables device 100 to communicate with other devices and/or systems. For example, communication interface 208 may include mechanisms for communicating via a network, such as the Internet, a terrestrial wireless network, a satellite-based network, etc. Additionally or alternatively, communication interface 208 may include a modem, an Ethernet interface to a LAN, and/or an interface/connection for connecting device 100 to other devices.

Display 210 may include a device that can display signals generated by device 100 as images on a screen. Examples of a display include a liquid crystal display (LCD), cathode ray tube (CRT) display, organic light-emitting diode (OLED) display, surface-conduction electron-emitter display (SED), plasma display, field emission display (FED), and bistable display. In practice, device 100 may include one or more displays.

Accelerometer 212 may include hardware and/or software for determining acceleration of device 100. An example of accelerometer 212 may include a micro electro mechanical system (MEMS) accelerometer or a piezoelectric accelerometer that is coupled to the device housing for measuring device acceleration in one, two, or three axes.

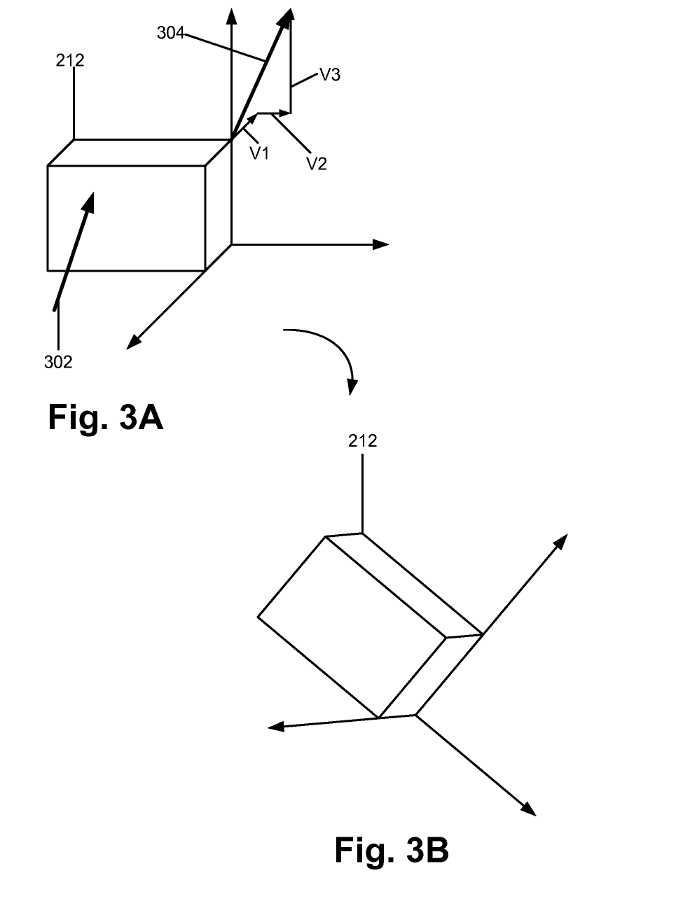

Acceleration measurements that are provided by accelerometer 212 may be relative to a coordinate system. FIG. 3A illustrates accelerometer 212 and a three-dimensional Cartesian coordinate system that is affixed to accelerometer 212. If accelerometer 212 moves to a new position or changes its orientation as illustrated in FIG. 3B, the coordinate system moves and rotates along with accelerometer 212.

When accelerometer 212 detects acceleration, accelerometer 212 may output its measurement as three separate values, each of which represents the magnitude of an acceleration component that is parallel to one of the accelerometer axes. For example, if device 100 is held in the orientation as illustrated in FIG. 3A, when it is pushed with force 302, the device may move in the direction as shown by arrow 304. Accelerometer 212 may decompose the acceleration into components V1, V2 and V3 and may output the magnitudes of V1, V2 and V3.

Referring back to FIG. 2, gyroscope 214 may include hardware and/or software for determining angular rates of device 100. The term “angular rate,” as used herein, may refer to the rate at which device 100 rotates. Angular rate may be measured in either degrees or radians per unit time. An example of gyroscope 214 may include a MEMS gyroscope that is coupled to the device housing for measuring angular rates about one, two, or three axes. The angular rates that are provided by gyroscope 214 may measure the rates of rotation of the coordinate frame that is affixed to device 100. In addition, the measurements are provided as three separate values, each of which represents the magnitude of an angular rate of device 100 around each axis of a reference coordinate system.

GPS receiver 216 may include hardware and/or software for receiving signals from GPS satellites and for producing device velocity and location information. Communication bus 218 may provide an interface through which components of device 100 can communicate with one another. Housing 220 may include a container for physically containing all components of device 100. The components of device 100 that are contained in housing 220 may be affixed to housing 220, directly or indirectly.

### Exemplary Process for Counting Steps

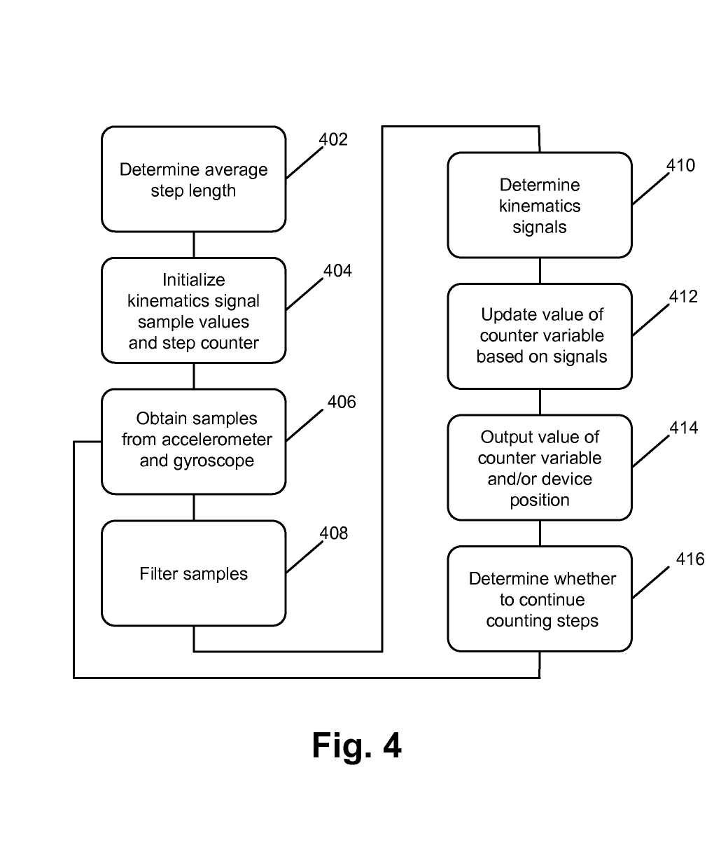

FIG. 4 shows an exemplary process for counting steps that may be implemented on device 100. At block 402, an average step length of a user may be determined. Depending on implementation, the step length may be determined in many ways. For instance, the step length may be inputted by the user.

At block 404, kinematics signal sample values and a step counter variable may be initialized. The term “initialize,” as used herein, may refer to any preparatory acts or processes that provide initial values to the signal samples and the step counter variable. In addition, the term “step counter variable” may refer to hardware and/or software that can be used for keeping track of the number of steps. In one implementation, initializing kinematics signal samples (i.e., the acceleration, velocity, and/or distance signal samples) and the step counter variable may set all values of the signal samples and the step counter variable to zero.

At block 406, signal samples from accelerometer 212 and gyroscope 214 may be obtained.

At block 408, the obtained samples may be filtered to eliminate noise and/or to remove undesirable characteristics. For instance, if accelerometer 212 is sensitive to temperature, vibrations, and/or minute changes in acceleration, a low pass filter may be applied to the samples to eliminate the noise.

In addition, the undesirable characteristics may be removed from the samples through filtering. For example, if the user carries device 100 in a purse and rocks the purse, accelerometer 212 and gyroscope 214 samples may exhibit characteristics that reflect the rocking motion. If the periodicity of the rocking motion is significantly different from that of user steps, it is possible to apply different types of filters to eliminate the undesirable characteristics.

At block 410, kinematics signals may be determined. In many implementations, a process for determining the kinematics signals may involve solving equations of motion. Given measurements of acceleration and angular rates, it is possible to solve the equations for velocity, distance, and device orientation in three-dimensions.

Simplified equations of motion may be derived from observing that device 100 may experience two acceleration components, g from gravity and a from specific forces that are applied on device 100. If \ddot{r}ⁱ denotes overall acceleration of device 100, it is possible to write:

g+a=\ddot{r}ⁱ. (1)

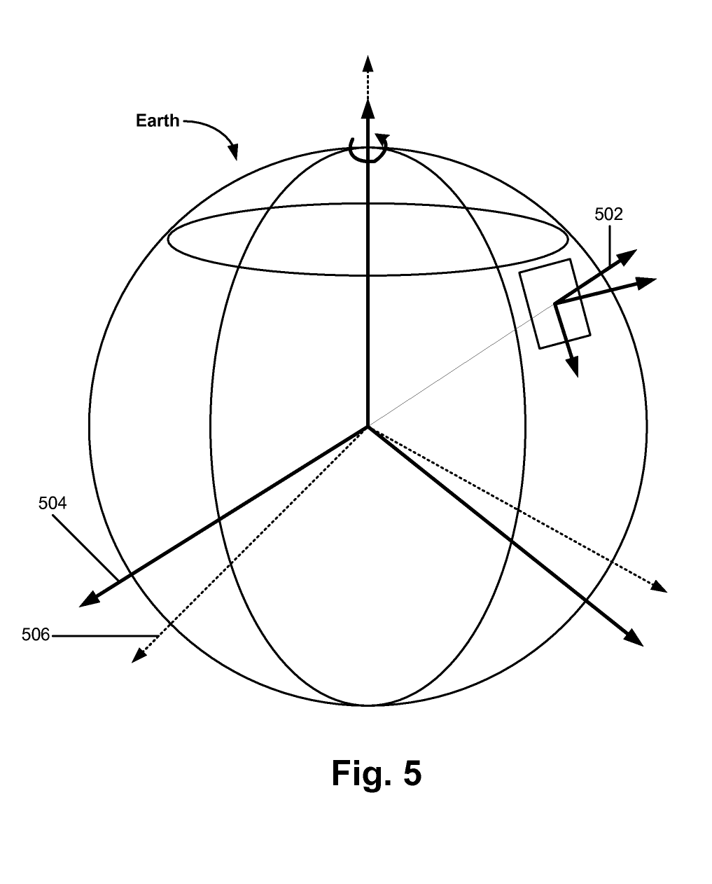

Solving the above equation may involve multiple coordinate frames of reference. More specifically, as illustrated in FIG. 5, it may involve a device frame 502, an Earth-centric frame 504, and inertial frame 506. As discussed previously, device frame 502 is attached to device 100 and moves with device 100. Earth-centric frame 504 is affixed to and rotates along with the Earth, about the Earth's spin axis. Inertial frame 506 is positioned so that its z-axis and its x-y plane coincide with the z-axis and x-y plane of Earth-centric frame 504. However, inertial frame 506 does not rotate with the Earth.

A general relationship between Earth-centric frame 504 and inertial frame 506 may be expressed as:

rⁱ=Rₑⁱr^{e}+qⁱ, (2)

where rⁱ and qⁱ may represent, in inertial frame 506, a position vector and a vector from the origin of inertial frame 506 to Earth-centric frame 504, respectively. Rₑⁱ may represent a rotational matrix that can be used to change a vector representation r^{e} of the device position in Earth-centric frame 504 to another vector representation in inertial frame 506.

Differentiating expression (2) twice with respect to time and recognizing that Earth-centric frame 504 is different from inertial frame 508 only in its rotation about the z-axis lead to:

\ddot{r}ⁱ=\ddot{r}^{e}+2Ωᵢₑ^{e}\dot{r}^{e}+\dot{Ω}ᵢₑ^{e}r^{e}+Ωᵢₑ^{e}Ωᵢₑ^{e}r^{e}+\ddot{q}. (3)

In expression (3), each dot represents a time derivative of the variable below the dot. In addition, Ωᵢₑⁱ can be defined by the relation:

\dot{R}ₑⁱ=RₑⁱΩᵢₑ^{e} (4)

In expression (4), Ωᵢₑ^{e} may represent a skew symmetric matrix form of angular rates (ωᵢₑₓ^{e}, ω_{iey}^{e}, ω_{iez}^{e}). Each of the terms (ωᵢₑₓ^{e}, ω_{iey}^{e}, ω_{iez}^{e}) relates the rate of rotation of Earth-centric frame 504 around one of inertial-frame axes. Noting that Earth-centric frame 504 rotates only about the z-axis of inertial frame 506, Ωᵢₑ^{e} may be expressed as:

$${Ω}_{ie}^{e} = [ \begin{matrix}0 & - {ω}_{dez}^{e} & 0 \\ {ω}_{dez}^{e} & 0 & 0 \\ 0 & 0 & 0\end{matrix} ] . \qquad ( 5 )$$

Device measurements are provided in device frame 502. Such measurements can be represented in Earth-centric frame 504 by the use of rotational matrix R_{b}^{e}. Differentiating R_{b}^{e} with respect to time yields an expression that is similar to (4):

\dot{R}_{b}^{e}=R_{b}^{e}Ω_{eb}^{e} (6)

In expression (6), Ω_{eb}^{b} may represent a skew symmetric matrix form of angular rates (ω_{ebx}^{b}, ω_{eby}^{b}, ω_{ebz}^{b}). Each of the terms (ω_{ebx}^{b}, ω_{eby}^{b}, ω_{ebz}^{b}) relates the rate of rotation of device frame 502 to Earth-centric frame 504. Ω_{eb}^{b} may be expressed in terms of the angular rates as:

$${Ω}_{eb}^{b} = [ \begin{matrix}0 & - {ω}_{ebz}^{b} & {ω}_{eby}^{b} \\ {ω}_{ebz}^{b} & 0 & {ω}_{ebx}^{b} \\ - {ω}_{eby}^{b} & {ω}_{ebx}^{b} & 0\end{matrix} ] . \qquad ( 7 )$$

Returning to simplifying the equations of motion, expression (1) that is given in inertial frame 506 may be combined with expression (3), to yield:

g+a=\ddot{r}^{e}+2Ωᵢₑ^{e}\dot{r}^{e}+\dot{Ω}ᵢₑ^{e}r^{e}+Ωᵢₑ^{e}Ωᵢₑ^{e}r^{e}+\ddot{q}. (8)

Expression (8) may be simplified by noting the following: \ddot{q} is zero, because the vector q from the Earth-centric frame's origin to the inertial frame's origin does not change.

If a on the left hand side of expression (8) is expressed in terms of fictitious acceleration a^{f} and acceleration a^{e} in Earth-centric frame 504, expression (8) may be rewritten as

g^{e}+a^{f}+a^{e}+\ddot{r}^{e}+2Ωᵢₑ^{e}\dot{r}^{e}+\dot{Ω}ᵢₑ^{e}r^{e}+Ωᵢₑ^{e}Ωᵢₑ^{e}r^{e}+\ddot{q}. (9)

Expression (9) may be further simplified by noting the following: \dot{Ω}ᵢₑ^{e}r^{e} and Ωᵢₑ^{e}Ωᵢₑ^{e}r^{e} in the right hand side of expression (9) correspond to fictitious acceleration a^{f} on the left hand side of expression (9). Rewriting expression (9) by dropping a^{f} on the left hand side of expression (9) and \dot{Ω}ᵢₑ^{e}r^{e} and Ωᵢₑ^{e}Ωᵢₑ^{e}r^{e} on the right hand side of expression (9) gives

g^{e}+a^{e}=\ddot{r}^{e}+2Ωᵢₑ^{e}\dot{r}^{e}. (10)

In expression (10), a^{e} may represent the measured value of acceleration in Earth-centric frame 504. However, the measurements from accelerometer 212 are provided in the coordinate system that is affixed to device 100. To transform the measured value a^{b} in device frame 502 to another in Earth-centric frame 504, it is possible to use the following expression:

a^{e}=R_{b}^{e}a^{b}. (11)

In the above, R_{b}^{e} may represent a rotational matrix that changes the vector representation a^{b} in device frame 502 to the vector representation a^{e} in Earth-centric frame 504.

Expressions (10) and (11) may be combined and solved for \ddot{r}^{e}, to produce

\ddot{r}^{e}=−2Ωᵢₑ^{e}\dot{r}^{e}+g+R_{b}^{e}a^{b}. (12)

If A(t), V(t), and D(t) denote acceleration, velocity, and distance vectors as functions of time in three-dimensions, it is also possible to express \ddot{r}^{e} as:

$${\ddot{r}}^{e} = A ( t ) = \frac{d V ( t )}{d t} = \frac{{d}^{2} D ( t )}{d {t}^{2}} . \qquad ( 13 )$$

Expressions (4)-(7), (12), and (13) describe the kinematics of device 100 in continuous time domain. They may be solved iteratively, by using numerical techniques (e.g., trapezoid-rule, Runge-Kutta, finite difference, finite element) to determine the kinematics signals (i.e., acceleration, velocity and distance signals).

Returning to FIG. 4, at block 412, the kinematics signals may be processed to update the value of the step counter variable. The velocity and distance signals may be processed in many different ways, and in one implementation, the velocity signal sample values may be summed over a given period to derive an incremental distance that has been traveled since the previous step. The value of the step counter variable may be increased if the distance traveled from the user position just after the previous step is greater than the average step length.

In another implementation, the step counter variable may be updated with the value of the quotient that is derived from dividing the overall travel distance by the average step length. The overall distance may be calculated by integrating the absolute value of the velocity signal from the start of the step counting process.

At block 414, the value of the step counter variable and/or device position may be outputted, depending on implementation and user inputs. For example, in one implementation, device 100 may update its display 210 with the value of the step counter variable.

At block 416, whether to continue counting user steps may be determined. If additional steps are to be counted, the step counting process may return to block 406 to obtain and process additional samples from accelerometer 212 and gyroscope 214. Otherwise, the process may terminate.

### Alternative Implementations

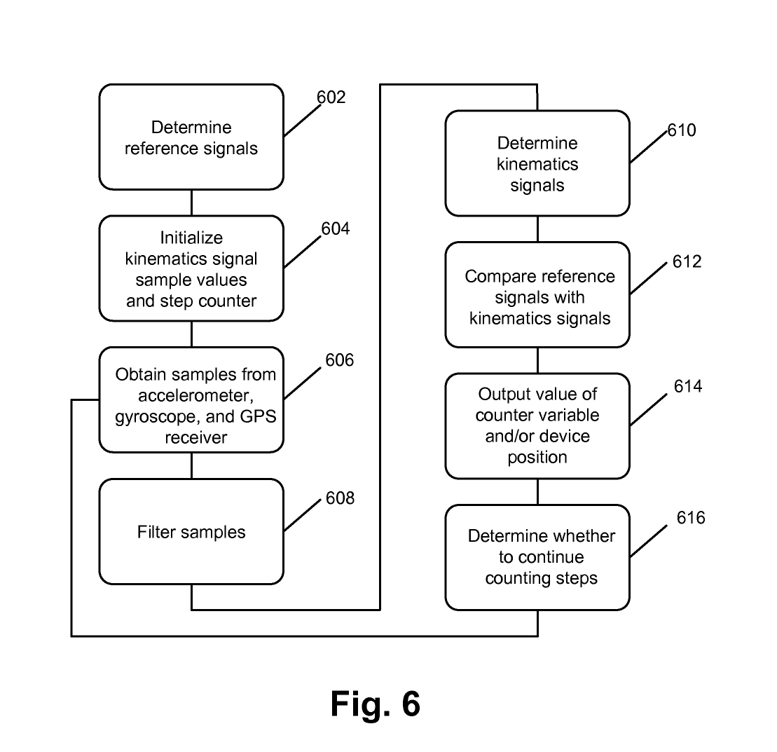

FIG. 6 shows another exemplary process for counting steps that may be implemented on device 100. At block 602, reference sample signals of a user may be determined. The reference signals may be derived during the construction of device 100, during calibration of various components, or during its use, by sampling outputs from accelerometer 212 and gyroscope 214 while the user takes physical steps.

At block 604, kinematics signal values and a step counter variable may be initialized. In one implementation, initializing kinematics signal samples (i.e., the acceleration, velocity, and/or distance signal samples) and the step counter variable may set all values of the signal samples and the step counter variable to zero.

At block 606, samples from accelerometer 212, gyroscope 214, and GPS receiver 216 may be obtained, and at block 608, the obtained samples may be filtered to eliminate noise or remove undesirable sample characteristics.

At block 610, the kinematics signals may be determined. In one implementation, a process for determining the kinematics signals may involve Kalman filtering. A Kalman filter may be derived by discretizing expressions (4)-(7), (12), and (13), and extending the discretized expressions to account for GPS signal inputs. The extended Kalman filter expressions may be solved iteratively to produce the kinematics signals and geographical location of device 100.

At block 612, the kinematics signals may be compared to the reference signals determined at block 602 to establish if there is a match between the kinematics signals and the reference signals. If there is a match, it may be established that a step or steps have been taken. The value of the step counter variable may be increased accordingly.

Many techniques may be employed in determining if there is a match. For instance, it is possible to compute the degree of overlap between the frequency components of the reference signals and the kinematics signals.

At block 614, the value of the step counter variable and/or device position may be outputted, depending on implementation and user inputs. For example, in one implementation, device 100 may update its display 210 with the value of the step counter variable. In another implementation, device 100 may update its display 210 with a local map, the geographical location of the device, and the value of the step counter variable.

At block 616, whether to continue counting user steps may be determined. If additional user steps are to be counted, the step counting process may return to block 606 to obtain additional samples from accelerometer 212, gyroscope 214, and GPS receiver 216. Otherwise, the process may terminate.

Implementations described above count user steps. However, it is possible to have implementations in which only distance is measured. Briefly, the following describes such an implementation, with reference to FIG. 4.

For only distance measurements, block 402 for determining average step length may be omitted. At block 404, kinematics signal sample values may be initialized. The step counter may not be initialized, because steps are not counted.

Blocks 406, 407, 408, and 410 may be performed as described previously. Performing block 410 yields the distance signal, which gives the distance measurement.

Block 412 may be omitted. At block 414, the measured distance and device position may be outputted, for example, to a display. The process may return to block 406 for continued distance and position measurements.

### EXAMPLE

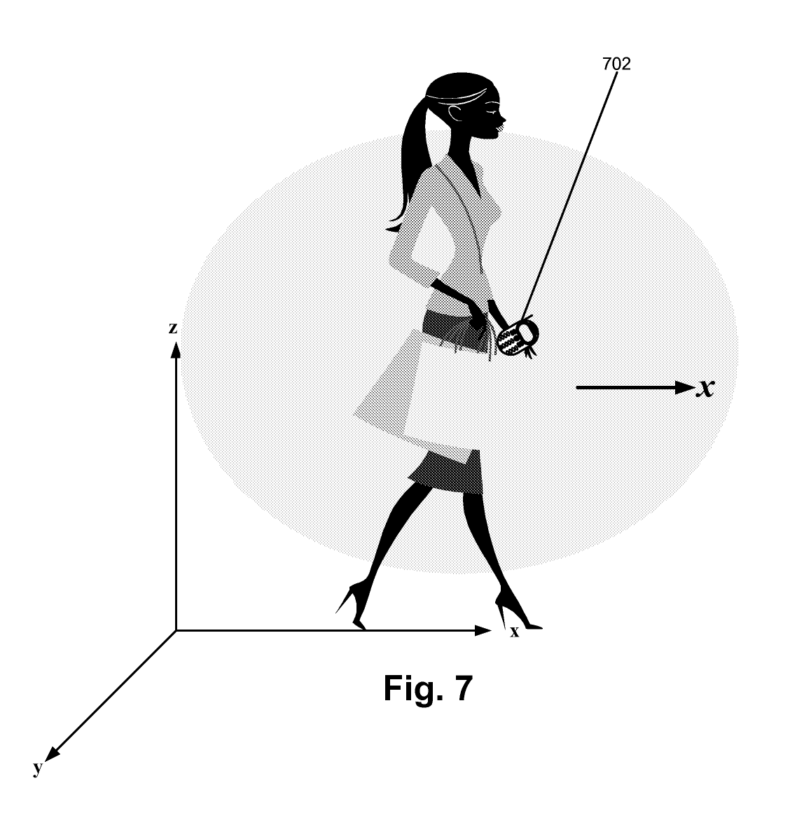

The following example illustrates processes involved in counting user steps, with reference to FIG. 7. The example is consistent with the exemplary process described above with reference to FIG. 4.

Assume that a user powers up phone 702 in FIG. 7 that includes accelerometer 212 and gyroscope 214. In addition, assume that phone 702 may accept four signal samples from accelerometer 212 and gyroscope 214. For the sake of simplicity, assume that acceleration signals are provided only in one axis (i.e., x-axis), and that phone 702 is held in a fixed orientation relative to the user at all times. Also assume that the output from accelerometer 212 due to a single step can be approximated by the function:

A(t)=|sin(πt/G)|+sin(2πft), where 0≦t≦1 second. (14)

Constant f in the second right hand term represents high-frequency noise that may be present in the accelerometer output. All outputs from gyroscope 214 are zero, as phone 702 is positioned in the fixed orientation.

In the example, after powering up phone 702, the user inputs an average step length of 0.3 meters into phone 702. Upon the entry of the average step length, phone 702 initializes its kinematics signals and step counter variable to zero. If the acceleration signal samples are represented as a 1×4 vector S, then, the following expression may represent the signal sample values.

S=[S₀,S₁,S₂,S₃,S₄]=[0,0,0,0,0]. (15)

In the above expression, S₀, S₁, S₂, S₃, and S₄ represent sampled outputs of accelerometer 212 at consecutive 0.25 second time intervals.

As the user walks, acceleration signal samples are obtained from accelerometer 212. In this example, accelerometer 212 outputs samples in accordance with expression (14). After obtaining the samples, vector S becomes:

$$S = [ 0 , sin ( π / 4 ) + sin ( π f / 2 ) , sin ( π / 2 ) + sin ( π f ) , sin ( 3 π / 4 ) + sin ( 3 π f / 2 ) , 0 ] . \qquad ( 1 \; 6 )$$

To remove noise, S is filtered with a digital low pass filter whose cut-off frequency is below f. The effect of the filtering is to remove the high frequency component of the signal. If S represents S after filtering, S can be written as

S=[0,\sqrt{2}/2,1,\sqrt{2}/2,0]. (17)

Assuming for the sake of simplicity that the rotational matrices are the identity matrices (i.e., Earth-centric frame and the device frame have the same orientation), numerically solving for the velocity signal using expressions (4)-(7), (12), (13) and (17) yields:

V=[0,0.088,0.39,0.69,0.78]. (18)

Expression (16) is used to obtain the numerical solution for distance, D:

D=[0,0.011,0.071,0.206,0.390]. (19)

Kinematics signals (17), (18), and (19) are used to count the number of steps. More specifically, the step counter variable may be increased if the distance traveled from the user position just after the previous step is greater than the average step length. In this example, the distance traveled after 1 second is given as 0.390 meter by (19), and it is greater than the average step length, which is 0.3 meter. The step counter variable is increased by one.

While phone 702 continues to count steps, additional samples may be obtained from accelerometer 212 and processed as described above.

### CONCLUSION

The foregoing description of embodiments provides illustration, but is not intended to be exhaustive or to limit the embodiments to the precise form disclosed. Modifications and variations are possible in light of the above teachings or may be acquired from practice of the teachings.

For example, while series of blocks have been described with regard to processes illustrated in FIGS. 4 and 6, the order of the blocks may be modified in other implementations. For example, block 408/608 may be performed after block 410/610. In addition, non-dependent blocks, such as block 614, may represent acts that can be performed in parallel. Further, certain blocks, such as block 614, may be omitted.

It will be apparent that aspects described herein may be implemented in many different forms of software, firmware, and hardware in the implementations illustrated in the figures. The actual software code or specialized control hardware used to implement aspects does not limit the invention. Thus, the operation and behavior of the aspects were described without reference to the specific software code—it being understood that software and control hardware can be designed to implement the aspects based on the description herein.

No element, act, or instruction used in the present application should be construed as critical or essential to the invention unless explicitly described as such. Also, as used herein, the article “a” is intended to include one or more items. Where only one item is intended, the term “one” or similar language is used. Further, the phrase “based on” is intended to mean “based, at least in part, on” unless explicitly stated otherwise.

It should be emphasized that the term “comprises/comprising” when used in this specification is taken to specify the presence of stated features, integers, steps or components but does not preclude the presence or addition of one or more other features, integers, steps, components, or groups thereof.

Further, certain portions of the invention have been described as “logic” that performs one or more functions. This logic may include hardware, such as a processor, an application specific integrated circuit, or a field programmable gate array, software, or a combination of hardware and software.

What is claimed is:

1. A method comprising:
obtaining samples from an accelerometer and a gyroscope;
determining kinematics signals based on the samples; and
computing a number of steps taken by a user based on the kinematics signals.

2. The method as in claim 1, wherein determining kinematics signals include:
determining an acceleration signal, a velocity signal, or a distance signal.

3. The method as in claim 1, further comprising:
removing noise from the obtained samples.

4. The method as in claim 1, further comprising:
receiving an average step length from the user.

5. The method as in claim 4, wherein computing a number of steps includes:
computing the number of steps taken by the user based on the kinematics signals and the average step length.

6. The method as in claim 1, wherein determining kinematics signals includes:
numerically solving equations of motion to determine kinematics signals based on the samples.

7. The method as in claim 1, further comprising:
receiving samples from a Global Positioning System (GPS) receiver.

8. The method as in claim 7, wherein determining kinematics signals includes:
numerically solving equations of motion based on the samples that are obtained from the accelerometer, the gyroscope, and the GPS receiver.

9. The method as in claim 1, further including:
initializing the kinematics signals.

10. A device comprising:
an accelerometer for providing acceleration measurements;
a gyroscope for providing angular rate measurements; and
a processor to:
accept the acceleration measurements from the accelerometer and the angular rate measurements from the gyroscope;
establish kinematics signals based on the acceleration measurements and the gyroscope measurements; and
count a number of user foot steps based on the kinematics signals and an average step length.

11. The device as in claim 10, wherein the kinematics signals includes:
a velocity signal, an acceleration signal, or a distance signal.

12. A device comprising:
a Global Positioning System (GPS) receiver for providing position measurements and velocity measurements;
an accelerometer for providing acceleration measurements;
a gyroscope for providing angular rate measurements; and
a processor to:
accept the position measurements from the GPS receiver, the velocity measurements from the GPS receiver, the acceleration measurements from the accelerometer, and the angular rate measurements from the gyroscope;
establish kinematics signals based on the position measurements, the velocity measurements, the acceleration measurements, and the angular rate measurements; and
count user foot steps by comparing the kinematics signals and reference kinematics signals.

13. The device as in claim 12, wherein the kinematics signals include:
a velocity signal, a acceleration signal, or a distance signal.

14. A device comprising:
means for detecting acceleration in a first coordinate frame;
means for detecting angular rates in the first coordinate frame;
means for determining kinematics signals in a second coordinate frame based on the detected acceleration and the detected angular rates; and
means for counting steps based on the kinematics signals.

15. The device as in claim 14, wherein the kinematics signals includes:
an acceleration signal, a velocity signal, or a distance signal in three dimensions.

16. The device as in claim 14, further comprising:
means for removing noise from the detected acceleration.

17. The device as in claim 14, further comprising:
means for receiving an average step length from a user that is carrying the device.

18. The device as in claim 17, wherein the means for counting steps includes:
means for counting steps taken by the user based on the kinematics signals and the average step length.

19. The device as claim 14, further comprising:
means for solving equations of motion to determine the kinematics signals based on the detected acceleration and the detected angular rates.

20. A portable device comprising:
an accelerometer for providing acceleration measurements;
a gyroscope for providing angular rate measurements;
a processor to:
accept the acceleration measurements from the accelerometer and the angular rate measurements from the gyroscope;
establish kinematics signals based on the acceleration measurements and the gyroscope measurements by solving equations of motions; and
measure a distance traveled based on the kinematics signals; and
a housing that contains components of the portable device, the components including the accelerometer, the gyroscope, and the processor.

21. The portable device as in claim 20, wherein the housing includes a cell phone housing, a laptop housing, an electronic notepad housing, or a personal digital assistant (PDA) housing, a pager housing, or a mobile telephone housing.
